(19) United States
(12) Patent Application Publication
(10) Pub. No.: US 2004/0254793 A1
(43) Pub. Date: Dec. 16, 2004

(54) System and method for providing an audio challenge to distinguish a human from a computer

(76) Inventors: Cormac Herley, Bellevue, WA (US); James Garnet Droppo III, Duvall, WA (US); Joshua Goodman, Redmond, WA (US); Josh Benaloh, Redmond, WA (US); Iulian Calinov, Redmond, WA (US); Jeff Steinbok, Redmond, WA (US)

Correspondence Address: Mark A. Watson, Lyon & Harr, Suite 800, 300 Esplanade Drive, Oxnard, CA, 93030, US

(21) Appl. No.: 10/459,912

(22) Filed: Jun. 12, 2003

(51) Int. Cl. G10L 21/00

(52) U.S. Cl. 704/270

(57) ABSTRACT

An “audio challenger” operates by first defining a library of a finite number of discrete audio objects including spoken sounds, such as, for example, individual digits, letters, numbers, words, etc., or combinations of two or more digits, letters, numbers, or words. The spoken sounds are either automatically generated by a computer, or recorded from one or more actual spoken voices. Given this library of audio objects, the audio challenger automatically selects one or more audio objects from the library and concatenates the objects into an audio string that is then automatically processed to add one or more distortions to create a “challenge string.” The distorted challenge string is then presented to an unknown party for identification. If the unknown party correctly identifies the challenge string, then the unknown party is deemed to be a human operator. Otherwise, the unknown party is deemed to be another computer.

### BACKGROUND

1. Technical Field

The invention is related to automatically determining whether a computer is in communication with a person or with another computer, and in particular, to a system and method for providing an audio challenge to a human listener that is easy for a human listener to understand and respond to, while it is very difficult for a computer to understand and respond to.

2. Related Art

There are many existing schemes for attempting to limit computer access to humans or to computers being actively controlled by humans while preventing access by autonomous computers or computer programs that are attempting to gain access. Often, such schemes are referred to as “Human Interactive Proofs,” or “HlPs.” For example, at least one conventional email service provider asks potential users to prove that they are human, and thus not another computer, before granting free email accounts. One rationale is that while it may take an individual user a minute or so to sign up for an email account, a single autonomous computer program can potentially obtain thousands of email accounts per second. Unfortunately, such computer acquired email accounts are often used for purposes such as flooding many thousands of legitimate email accounts with unwanted and unsolicited commercial email.

The goal of most HIP schemes is to prevent automated access by a computer, while allowing access by a human. Typically, this goal is addressed by providing a method for generating and grading tests that most people can easily pass, and that most computer programs can't pass. For example, one conventional scheme operates by randomly selecting words from a dictionary, then rendering a distorted image containing the words. This scheme then presents a test to its user which consists of the distorted image and a request to type some of the words appearing in the image. By tailoring the types of deformations that are applied, an image is created wherein most humans can read the required number of words from the distorted image, while current computer programs typically can't.

Another conventional scheme operates by asking the user to solve a visual pattern recognition problem. In particular, it displays images of two series of blocks, with one series differing from the other in some manner. The user is then asked to find the characteristic that sets the blocks apart. After being presented with the two series of blocks, the user is then presented with a single test block and is asked to determine which series the test block belongs to. The user passes the test if he or she correctly determines the matching series of blocks. Such tests, while relatively easy for humans, tend to be difficult for computer programs to solve reliably.

Still another conventional scheme for preventing automated access involves a program that has a large database of labeled images, such as, for example, pictures of a horse, a table, a house, a flower, etc. This scheme then picks an object at random, extracts several images of that object from the database, and presents them to the user. The user is then required to state what the pictures represent. For example, in response to several pictures of a house, the user would respond with the answer “house.” Again, such tests, while relatively easy for humans, tend to be difficult for computer programs to reliably solve.

Finally, another conventional scheme for preventing automated access involves a sound-based test for attempting to limit access to human users. This scheme is based on the superior ability of humans over computers to recognize spoken language. In particular, this scheme picks a word or a sequence of digits at random, renders the word, or the digits, into a sound clip that is then distorted. It then presents the distorted sound clip to the user and asks the user to enter the contents of the sound clip. A related scheme is based on the abilities of humans to pay attention to a particular sound source. Specifically a user is presented with a sound clip containing two voices. One of the voices expresses a series of digits in a user specified language, while the second, overlapping, voice expresses words in another language. In order to pass the test, the user must distinguish between the voices and enter the spoken digits within some error tolerance. Again, such tests, while relatively easy for humans, tend to be difficult for computer programs to reliably solve.

However, such schemes are often inefficient or subject to attack by a computer recognition program that can record and analyze the presented challenges over time. Further, any HIP scheme which is visual in nature may not be acceptable for individuals that are blind or otherwise visually impaired.

Therefore, what is needed is a system and method that provides a Human Interactive Proof that is difficult for a computer to solve, even where that computer has the opportunity to record and analyze multiple challenges over a period of time. Further, any such system and method should be useful for those individuals that are blind or otherwise visually impaired.

### SUMMARY

In certain applications it is important for a computer application to determine whether it is interacting with a human or a computer. For example, a server might wish to determine whether a client that contacts it to request opening an email account is a human, or whether it is a computer script that is capable of automatically generating such requests. To address this problem, an “audio challenger” as described herein provides a system and method for determining whether an unknown party that is in communication with a computer is a human, or whether it is another computer. In general, this audio challenger presents the unknown party with a speech recognition task that is easily performed by humans, but difficult for computers to reliably solve. For example if the challenge were an audio clip of the spoken characters “2f4dg345” then the response should be the string “2f4dg345” to successfully satisfy the system that a human and not a computer has responded. Note that such an audio challenge is especially useful for people who are blind or visually impaired.

In general, the audio challenger operates by first defining a library of a finite number of discrete audio objects. These discrete audio objects include spoken sounds, such as, for example, individual digits, letters, numbers, words, etc., or combinations of two or more digits, letters, numbers, or words. The spoken sounds are either automatically generated by a computer, or recorded from one or more actual spoken voices. Given this library of audio objects, the audio challenger automatically selects one or more audio objects from the library and concatenates the objects into a “challenge string.” This challenge string is then automatically processed to add one or more distortions. The addition of such distortions serves to create an audio string that is relatively easy for a person to recognize, but difficult for a computer to recognize. The distorted challenge string is then presented to the unknown party for identification. If the unknown party correctly identifies the challenge string, then the unknown party is deemed to be a human operator. Otherwise, the unknown party is deemed to be another computer.

One distortion that is added to the challenge string is referred to herein as “babble.” In general, this babble is created from an audio clip of either spoken or computer generated language or sounds. Specifically, one or more sequences of audio having a length greater than the concatenated challenge string are sampled at random locations using a sample size that is equal to or greater than that of the challenge string. Two or more of the random samples are then overlaid or combined using conventional audio processing techniques such that the resulting audio or “babble” seems to a listener to be two or more speakers talking at once. This babble is then combined with the challenge string, again using conventional audio processing techniques such that the resulting challenge string seems to a listener to be a sequence of audio objects being spoken at the same time as the speech of two or more other speakers. This background of random babble, when added to the challenge string creates a distorted challenge string that is still fairly easy for a human listener to interpret, while it is fairly difficult for a computer to interpret.

In addition to the random babble that is added to the challenge string, other distortion, including, for example, reverb, popping noises, clipping, narrow band sounds such as sirens and whistles, and time or frequency domain distortions of the challenge string may also be added. Any or all of these distortions are added in any desired combination to the challenge string to create the distorted challenge string.

Once the challenge string distortions have been added to the challenge string, the next step is to send or present the challenge string to the unknown party for identification. The unknown party is then required to respond by typing the sequence of audio objects represented by the distorted challenge string. This typed response is then compared to the challenge string. Only if the typed response matches the challenge string is the unknown user deemed to be a human. However, in a related embodiment, the match does not have to be exact. For example, so long as the typed response of the unknown user matches the challenge string within some predetermined error tolerance or threshold, than the unknown user is still deemed to be a human user.

In addition to the just described benefits, other advantages of the system and method for automatically determining whether an unknown user is a human or a computer via an audio challenge will become apparent from the detailed description which follows hereinafter when taken in conjunction with the accompanying drawing figures.

### DESCRIPTION OF THE DRAWINGS

The specific features, aspects, and advantages of the present invention will become better understood with regard to the following description, appended claims, and accompanying drawings where:

FIG. 1 is a general system diagram depicting a general-purpose computing device constituting an exemplary system for automatically determining whether an unknown user is a human or a computer via an audio challenge.

FIG. 2 illustrates an exemplary architectural diagram showing exemplary program modules for automatically determining whether an unknown user is a human or a computer via an audio challenge.

FIG. 3 illustrates an exemplary system flow diagram for automatically determining whether an unknown user is a human or a computer via an audio challenge.

### DETAILED DESCRIPTION OF THE PREFERRED EMBODIMENTS

In the following description of the preferred embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

1.0 Exemplary Operating Environment:

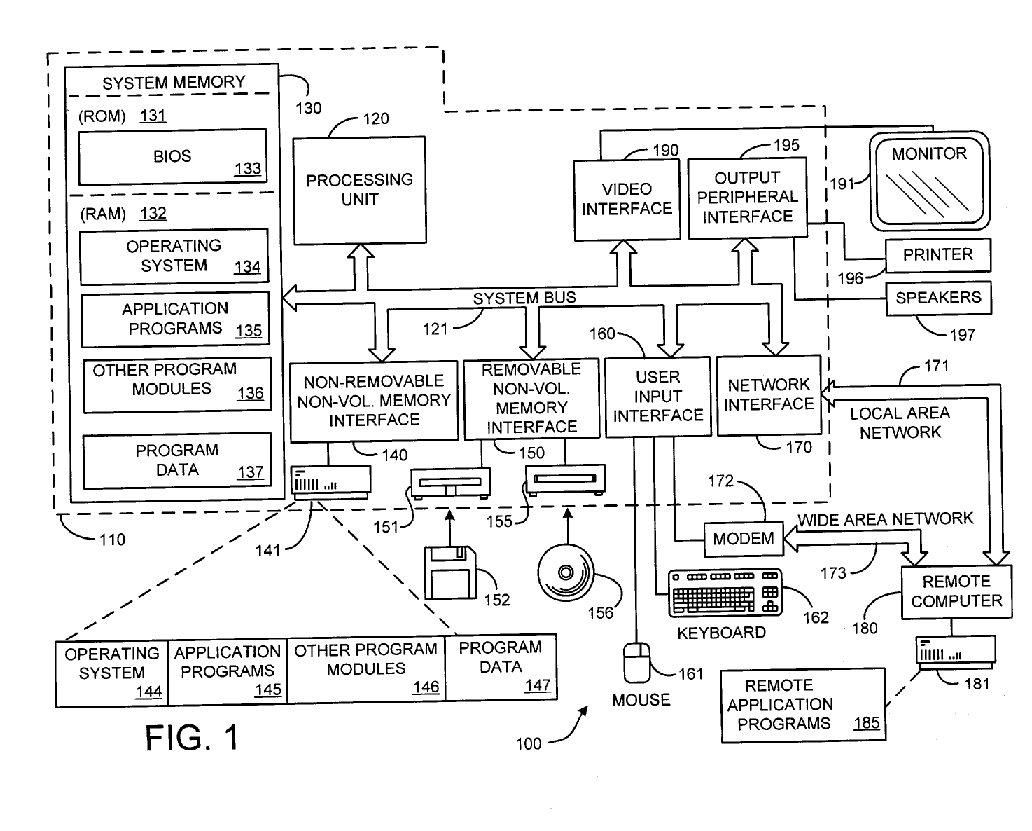

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 1, an exemplary system for implementing the invention includes a general-purpose computing device in the form of a computer 110.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules, or other data.

Computer storage media includes, but is not limited to, RAM, ROM, EEPROM, flash memory, or other memory technology; CD-ROM, digital versatile disks (DVD), or other optical disk storage; magnetic cassettes, magnetic tape, magnetic disk storage, or other magnetic storage devices; or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball, or touch pad.

Other input devices (not shown) may include a microphone, joystick, game pad, satellite dish, scanner, radio receiver, a television or broadcast video receiver, or the like. These and other input devices are often connected to the processing unit 120 through a user input interface 160 that is coupled to the system bus 121, but may be connected by other interface and bus structures, such as, for example, a parallel port, game port, or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining part of this description will be devoted to a discussion of the program modules and processes embodying a system and method for automatically determining whether an unknown user is a human or a computer via an audio challenge.

2.0 Introduction:

An “audio challenger,” as described herein, provides a reliable and straightforward method for allowing an unattended computer application to determine whether it is interacting with a human or merely with another computer, a computer script, or application. In general, the audio challenger operates by presenting an unknown party with a speech recognition task that is easily performed by humans, but difficult for computers to reliably solve. The speech recognition task presented by the audio challenger involves user identification of an audio challenge string. This audio challenge string is created by first concatenating a number of discrete audio objects into an audio string, then adding at least one layer of distortion to the audio string, thereby creating a challenge string which is difficult for a computer to interpret. This audio challenge string is then presented to the unknown party for identification. For example if the challenge string were an audio clip of the spoken characters “2f4dg345” then the response should be the text string “2f4dg345” to successfully satisfy the system that a human and not a computer has responded. Note that such an audio challenge is especially useful for people who are blind or visually impaired.

2.1 System Overview:

In general, the audio challenger operates by using a library of discrete audio objects in combination with one or more audio distortions in creating the challenge string. These discrete audio objects include spoken sounds, such as, for example, individual digits, letters, numbers, words, etc., or combinations of two or more digits, letters, numbers, or words. Each entry in the library includes an audio clip representing an audio object, as well as the characters representing that object. For example, a library entry representing the letter “r” will include the spoken sound “r” and the character “r,” so as to allow for user identification of the spoken sound by comparison of the library entry to a typed user response.

One advantage of using combinations of two or more letters, numbers or words as a single audio object, rather then simply concatenating individual audio objects to achieve the same combination, is that such combinations can be used to represent speech coarticulation effects. For example, as is well known to those skilled in the art, in speaking, a speaker does not necessarily create pauses or discrete separations between adjacent vowels or consonants, even where those adjacent vowels and consonants would otherwise represent breaks between adjacent words. Instead, as a result of speech coarticulation effects, the speaker typically creates speech where one vowel or consonant blends smoothly into the next. While such speech is naturally easy for humans to recognize, it tends to be more difficult for computers to recognize or interpret.

The spoken sounds representing the audio objects are either automatically synthesized by a computer, or recorded from one or more actual spoken voices. Note that throughout the following discussion, where “a single voice,” a “single speaker,” an “individual speaker”, or the like is referred to, it is intended to encompass both the recorded voice of an individual person and the synthesized voice of a computer program using a consistent set of speech synthesis parameters. In either case, given this library of audio objects, the audio challenger automatically selects one or more audio objects from the library and concatenates the objects into an audio string. In one embodiment, audio objects that represent only a single speaker are concatenated to create the audio string.

Given the concatenated audio string, the aforementioned challenge string is then created by automatically processing the audio string to add one or more levels or layers of distortions. The addition of such distortions serves to create an audio string that is relatively easy for a person to recognize, but difficult for a computer to recognize. The distorted challenge string is then presented to the unknown party for identification. If the unknown party correctly identifies the challenge string, then the unknown party is deemed to be a human operator. Otherwise, the unknown party is deemed to be another computer.

One distortion that is added to the challenge string is referred to herein as “babble.” In general, this babble is created from an audio clip of either spoken or computer generated language or sounds. Specifically, one or more sequences of audio having a length greater than that of the concatenated challenge string are sampled at random locations using a sample size that is equal to or greater than the length of the challenge string. Two or more of the random samples are then overlaid or combined using conventional audio processing techniques such that the resulting audio or “babble” seems to a listener to be two or more speakers talking at once. This babble is then combined with the challenge string, again using conventional audio processing techniques such that the resulting challenge string seems to a listener to be a sequence of audio objects being spoken at the same time as the speech of two or more other speakers. This background of random babble, when added to the challenge string creates a distorted challenge string that is still fairly easy for a human listener to interpret, while it is fairly difficult for a computer to interpret.

In addition to the random babble that is added to the challenge string, other distortions, including, for example, reverb, popping noises, clipping, narrow band sounds such as sirens and whistles, and time or frequency domain distortions are added to the challenge string. Any or all of these distortions are added in any desired combination to the challenge string to create the distorted challenge string. Many of the possible distortions can be added with different levels. For example additive noise can be made stronger or weaker, while a reverb filter can be made longer or shorter. The ability to vary the strength of distortions creates the ability to vary challenges by altering the strength with which different distortions are added from instance to instance of the challenge.

Once the challenge string distortions have been added to the challenge string, the next step is to send or present the challenge string to the unknown party for identification. The unknown party is then required to respond by typing the sequence of audio objects represented by the distorted challenge string. This typed response is then compared to the challenge string. Only if the typed response matches the challenge string is the unknown user deemed to be a human. However, in a related embodiment, the match does not have to be exact. For example, so long as the typed response of the unknown user matches the challenge string within some predetermined error tolerance or threshold, than the unknown user is still deemed to be a human user.

2.2 System Architecture:

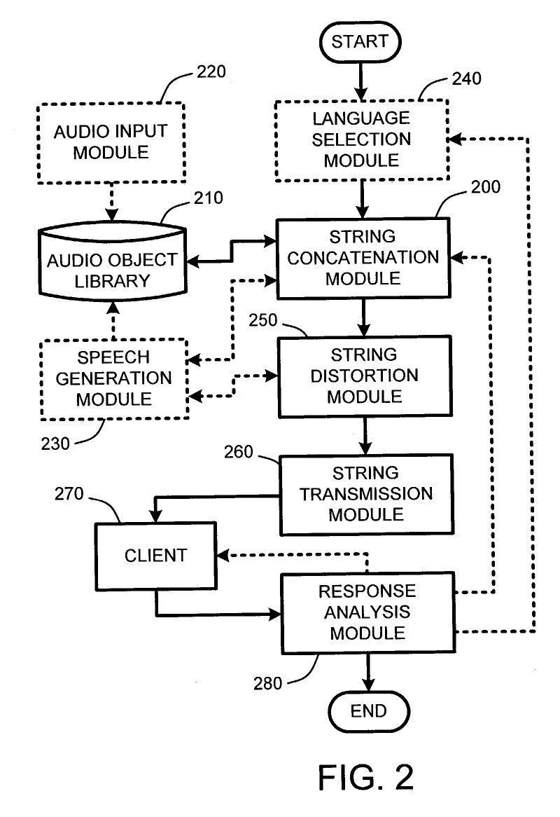

The processes summarized above are illustrated by the general system diagram of FIG. 2. In particular, the system diagram of FIG. 2 illustrates the interrelationships between program modules for implementing a speech-based audio challenge. It should be noted that the boxes and interconnections between boxes that are represented by broken or dashed lines in FIG. 2 represent alternate embodiments of the audio challenger described herein, and that any or all of these alternate embodiments, as described below, may be used in combination with other alternate embodiments that are described throughout this document.

In particular, as illustrated by FIG. 2, a system and method for implementing a human interactive proof using an audio challenge begins by using a string concatenation module 200 to select two or more audio objects from an audio object library 210. In one embodiment, selection of the audio objects from the audio object library 210 is random in both number and objects. In another embodiment, selection of the audio objects from the audio object library 210 is preprogrammed so that predetermined audio objects are selected.

As noted above, the audio object library 210 is populated with audio objects that include spoken sounds, such as, for example, individual letters, numbers, words, etc., or combinations of two or more letters, numbers or words. In one embodiment, an audio input module 220 is used to record spoken audio objects from one or more human speakers. In an alternate embodiment, a speech generation module 230 uses conventional speech synthesis techniques to synthesize the audio objects.

In one embodiment, the speech generation module 230 uses a consistent set of speech synthesis parameters to synthesize audio object entries in the audio object library 210. The effect of using a consistent set of speech synthesis parameters to synthesize audio objects is that those audio objects will effectively have the same “voice,” thereby making it more difficult for a computer to segregate the challenge string by looking for discontinuities in the voice. In a related embodiment, the audio object library is populated with unique voices by randomizing the speech synthesis parameters used to synthesize audio objects for each particular voice, while maintaining consistency for each individual voice. In this embodiment, the string concatenation module 200 selects either from those audio objects represented by a common voice, or from audio objects represented by a multiple voices. Note that providing a library of multiple “voices” allows the string concatenation module 200 to use a different voice for every unique audio challenge string, thereby making it more difficult for a computer to analyze and correctly respond to audio challenge string.

In yet another embodiment, the audio object library 210 comprises audio objects in two or more languages. In this embodiment, a language selection module 240 is provided to the unknown user to allow for selection of a preferred language. In operation, the unknown user simply selects a desired language from a list of available languages. The string concatenation module 200 then selects audio objects only in the user selected language. In this manner, localization of the audio challenger for any spoken language is easily accomplished.

Once selected, the string concatenation module 200 then concatenates the audio objects by using conventional techniques to form a composite audio string. Such concatenation techniques are well known to those skilled in the art, and will not be described in detail herein. Note that in one embodiment, the string concatenation module 200 concatenates the audio objects using a random spacing or pauses between audio objects in order to prevent or limit potential computer attacks based on knowing the length of the concatenated audio string. These pauses are either filled with a low level random noise, such as white noise, or simply left empty. In either case, the distortion that is later added to the concatenated audio string will serve to eliminate any complete silence between audio objects that would allow a computer to readily identify discrete audio objects within the challenge string.

Once the audio objects have been concatenated, the resulting audio string is provided to a string distortion module 250. Note that in one embodiment, the speech generation module provides an audio string comprising one or more synthesized audio objects directly to the string distortion module 250. This embodiment is advantageous in that the speech generation is capable of generating any desired string of any desired length, including random strings of random lengths without the need to concatenate individual audio objects. In either case, once the string distortion module 250 receives the audio string, the string distortion module then adds one or more layers of distortion to the audio string. Once distorted, the resulting audio string becomes the challenge string that will be used in the subsequent challenge to the unknown user as a Human Interactive Proof (HIP).

As noted above, the distortions applied by the string distortion module including any desired combination of random babble, reverb, popping noises, clipping, narrow band sounds such as sirens and whistles, and time or frequency domain distortions, are added to the challenge string. As will be appreciated by those skilled in the art, there are many other conventional types of audio distortions that are applicable to the audio string. The audio challenger described herein is fully capable of operating with any such distortions.

After creating the challenge string by adding the aforementioned distortions to the audio string, a string transmission module 260 then provides the challenge string to a client computer 270 for presentation to the unknown user. Presentation to the unknown user is made using conventional audio output devices, such as one or more computer speaker devices. The unknown user is then given the opportunity to type a response to the audio challenge. This response is then provided to a response analysis module 280 for comparison of the response to the audio objects that were used to construct the audio challenge string.

In one embodiment, if the response matches the audio objects used to construct the audio challenge string, then the unknown user is deemed to be a human, else, the user is deemed to be a computer or a computer script. Alternately, in one embodiment, the response of the unknown user is required to match the audio objects used to construct the audio challenge string within a predetermined threshold or tolerance. For example, the unknown user may be allowed to incorrectly identify one or more of the audio objects that were used to construct the audio challenge string while still being deemed to be a human user.

Several additional embodiments are used to address the case where one or more errors are observed in the response of the unknown user. In particular, in one embodiment, if errors are observed in the response, then the unknown user is presented with repeated opportunities to enter the correct response to the audio challenge string until a correct response is entered. In a related embodiment, the unknown user is given a limited number, e.g. three tries, to correctly respond before being deemed to be a computer or a computer script as the result of repeated failures to provide a matching response. In yet another embodiment, after one or more failures, the response analysis module calls the string concatenation module 200 to generate a new audio string which is then used to generate a new audio challenge string as described above for presentation to the unknown user via the client computer 270. Finally, in yet another embodiment, after one or more failures, the response analysis module calls the language selection module 240 to allow the unknown user to change the current language selection as described above. Following a change in the selected language, a new audio challenge string is then generated as described above for presentation to the user.

3.0 Operation Overview:

The above-described program modules are employed in an audio challenger for automatically generating an audio challenge string and presenting that challenge string to an unknown user for identification. The following sections provide a detailed operational discussion of exemplary methods for implementing the aforementioned program modules.

3.1 Operational Elements:

As noted above, the audio challenger creates an audio challenge string which is presented to an unknown user. The unknown user is then required to correctly identify some or all of the individual audio objects that were used in creating the audio challenge string in order to be deemed a human. One of the reasons that it is difficult for a computer to identify these audio objects is that after concatenation, one or more distortions are added to the resulting audio string. The following sections describe audio object library, concatenation of audio objects, and the generation of several novel and conventional types of distortion for addition to the audio string for creation of the final audio challenge string that is presented to the unknown user.

3.1.1 Audio Object Library:

In general, the audio object library has N characters or words available {{c₀, c₁, . . . , c_{N-1}}, and has an audio clip for each of them which consists of the spoken character or word represented by {w₀, w₁, . . . , w_{N-1}}. For example, where c₀ is the numeral “0”, then w₀ will be an audio clip of the spoken digit “zero.” As noted above, the audio clips representing these objects are provided by either recording one or more human speakers, or by automatically synthesizing one or more voices. Further, in one embodiment, the audio object library is also segmented into one or more language sections such that a user can select the language to be used for creating the audio challenge string. Note that frequent cycling or replacement of the voices, or of the characters or words available to the audio object library, serves to create a library of audio objects that is more difficult for a computer to learn over time.

The size of the library is directly related to the number of unique combinations of audio objects that can be created. For example, if the library only contains the numbers 0 through 9 and the letters of the alphabet, there would be a total of 36 characters or “audio objects” in the library. Assuming combinations of 8 audio objects, e.g., Θ2f4dg345”, then the total number of possible sequences of the objects in the library will exceed 1 trillion. Clearly, if the lengths of the strings are increased, then the number of possible sequences will also increase. Further, as the lengths of the strings are increased, it typically becomes more difficult for a computer to decipher the resulting audio challenge string. However, it also becomes more difficult for a human listener to correctly respond to random strings of letters and digits as the size of the random string increases. While any size string length can be used, a string length of about 4 objects to about 11 objects was observed to work well in a tested embodiment. Note that the use of words as audio objects, in addition to the letters and digits, will increase the number of possible sequences dramatically while again making it more difficult for a computer to correctly decipher the resulting combinations.

3.1.2 Concatenation of Audio Objects:

The challenge string is M characters (i.e., “audio objects”) long, with M being a either a predetermined number, or a number chosen randomly, within some predetermined limits, e.g. 4 to 11 characters represented by digits, letters, numbers, and words. Thus, for each audio challenge string, an audio string is generated by randomly selecting M characters from the N available. In other words, the first character of the challenge string is chosen by letting k be a random integer in the range {0, 1, . . . , N-1}, thus, for k=0, cₖ and wₖ are the first character and first audio clip of the challenge, and so on. Selecting each audio object or clip from the audio object library thus results in the selection of M characters and M audio clips. The M characters and M audio clips are then separately concatenated, with or without random length pauses between the audio clips to form a length M character string s, and an audio clip a approximately M times as long as the individual audio clips. The character string s is used in comparing the response of the unknown user to the audio challenge string.

3.1.3 Distortion of the Audio Clip:

The audio string a is intentionally distorted by either or both filteringfand the addition of noise n. Filtering is applied either before or after the addition of noise such as random babble. The use of filtering and addition of noise exploits the fact that speech recognition methods respond poorly in the presence of some forms of distortion. Given these variables, the final audio challenge string b can then be represented by Equation 1a and 1b, which illustrate filtering both before and after the addition of noise, respectively:

b=f*a+n Equation 1a

b=f*(a+n) Equation 1b

The audio challenge string b is then presented to the unknown user as described above. In one embodiment relative strengths of the filtered signal and the added noise are controlled. In particular, first the norms of f(a) and n are calculated using any suitable norm. Next, b is calculated as illustrated by Equation 2:

b=f*a+(|f*a|/|n|)n10^{(-SNR/20)} Equation 2

where SNR is a parameter that allows control of the relative signal to noise strength, and the denominator 20 associated with SNR is simply a number chosen for convenience.

3.1.3.1 Reverb:

One type of filter that is used for creating a distortion to be added to the signal a is a filter that simulates the effect of reverberation. Reverberation is caused when multiple copies of the same sound are distorted and delayed differently and interfere with each other. It is common in enclosed spaces where sounds that have bounced off one or more walls arrive later than the direct signal. In one embodiment a novel type of reverb is applied which uses a length P filter with taps f(n)=eⁿ r(n) for n={0, 1, . . . , P-1}, where e is a value between 0 and 1, and r(n) is a random number from a suitable distribution. This simulates the effect of superimposing many copies of the signal. Each copy is delayed by an amount between 0 and P-1 samples, and weighted by an amount eⁿ r(n). Since eⁿ becomes smaller with n, later copies are on average weighted less than earlier ones. The filter is also made random rather than deterministic by multiplying it by a number r(n) which is chosen from a random distribution for each n.

It has been observed in a tested embodiment that for good choices of P, the filter has length equivalent to 0.5 seconds or more. That is, if the audio clip a is sampled at 8000 samples per second, then a P greater than about 4000 or so is a suitable choice. Further, values of e between about 0.95 and 1.0 have been observed to produce good reverberation results. Finally, as noted above, the reverb filter can be different for each audio challenge since r(n) is chosen randomly. This randomness in the reverb serves to make it more difficult for a computer to learn and filter out the reverb so as to make automated speech recognition an easier task.

3.1.3.2 Babble:

In general, babble noise created by the audio challenger described herein is designed to sound similar to the background babble heard in crowded public places. In one embodiment, recordings of such babble are simply made then provided for sampling and use as babble noise in distorting the audio challenge string. However, rather than needing to actually record such babble, in one embodiment, the babble used by the audio challenger is automatically created from an audio clip of either spoken or computer generated language or sounds. The background of random babble, when added to the challenge string creates a distorted challenge string that is still fairly easy for a human listener to interpret, while it is fairly difficult for a computer to interpret.

To create the babble noise, one or more sequences of speech-type audio having a length greater than the concatenated challenge string are sampled at random locations or offsets using a sample size that is equal to or greater than the challenge string. Further, to ensure that the babble sequence is different for each audio challenge string, a relatively large amount of prerecorded or synthesized speech is provided for sampling purposes. Two or more of the random samples are then overlaid or combined using conventional audio processing techniques such that the resulting audio or “babble” seems to a listener to be two or more speakers talking at once. Further, in one embodiment, each sample used in constructing the babble is weighted using either random or predetermined weights prior to overlaying the samples used to create the babble. As a result, the babble includes perceptually “softer” and “louder” voices, thereby increasing the perceived realism of the babble, and making it more difficult for a computer to separate the audio objects within the challenge string from the babble noise within the challenge string.

As noted above, the babble can be created from one or more recorded or synthesized voices. For example, to create a babble string of 5 seconds in length from a single recorded voice of 5 minutes in length, two or more five-second segments are sampled from random positions within the recorded voice. Each of these random samples is then overlaid, with or without the use of weighting for each sample to create a five-second segment of overlapping voices that simulates actual babble noise. Even though the samples are drawn from the same voice in this example, the results will still sound like random babble, especially as the number of samples is increased, and where random weighting of the samples is used. Similarly, the samples can be drawn from any number of different voices, real or synthesized, with the realism of the babble being increased as the number of unique voices and random weighting of the samples is increased. Finally, in another embodiment prerecorded or synthesized speech of two or more speakers that are speaking at the same time is also sampled for constructing more complicated babble noise.

3.1.3.3 Other Distortions:

As noted above, any other desired distortion may also be applied to the audio string a for use in creating the final audio challenge string b. For example, in addition to the random babble described above, distortions including reverb, popping noises, clipping, narrow band sounds such as sirens and whistles, and time or frequency domain distortions, are added to the challenge string. The time and frequency domain distortions also include the capability to linearly or non-linearly stretch or compress audio with or without maintaining the signal pitch. Note that such compression and stretching techniques are well known to those skilled in the art. Further, as will be appreciated by those skilled in the art, there are many other conventional types of audio distortions that are applicable to the audio string. The audio challenger described herein is fully capable of operating with any such distortions. Methods for applying such distortions to an audio signal are well known to those skilled in the art, and will not be described in further detail herein.

3.2 System Operation:

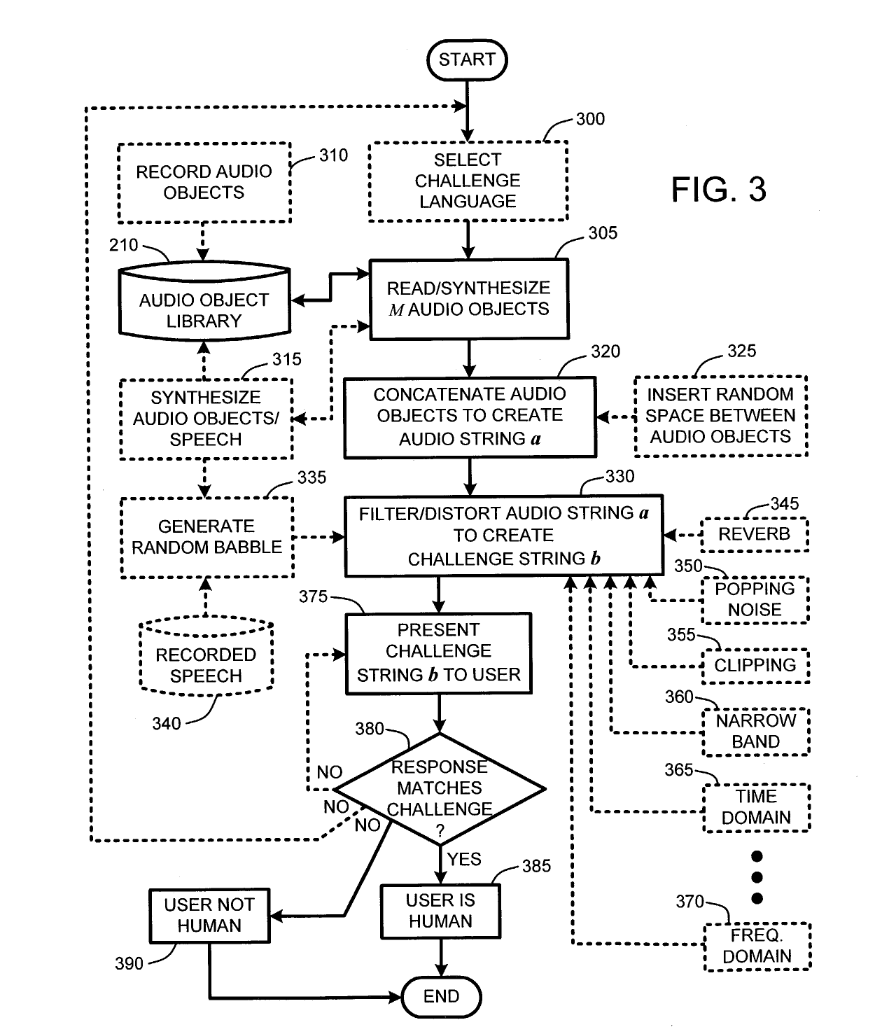

As noted above, the program modules described in Section 2.0 with reference to FIG. 2, and in view of the more detailed description provided in Section 3.1, are employed for automatically generating and presenting an audio challenge to an unknown user for recognition or identification. This process is depicted in the flow diagram of FIG. 3, which represents alternate embodiments of the audio challenger. It should be noted that the boxes and interconnections between boxes that are represented by broken or dashed lines in each of these figures represent further alternate embodiments of the audio challenger, and that any or all of these alternate embodiments, as described below, may be used in combination.

Referring now to FIG. 3 in combination with FIG. 2, in one embodiment, the process can be generally described as a system and method for providing a human interactive proof in the form of an audio challenge. In particular, as illustrated by FIG. 3, a system and method for providing an audio challenge to an unknown user begins by optionally selecting a challenge language 300. As discussed above, when selected, the audio challenge string will be presented to the unknown user in the selected language.

Next, whether or not a challenge language has been selected 300, the audio challenger either reads or synthesizes audio objects 305. When reading the audio objects, those objects are read from the aforementioned audio object library 210. As described above, the audio object library 210 is populated by either recording 310 one or more voices speaking those audio objects, or by automatically synthesizing one or more voices to create those audio objects. Alternately, rather than reading the audio objects from the audio object library 210, the audio objects are synthesized 315 in real time and read directly.

Once the audio objects have been either read or synthesized 305, the audio objects are then concatenated into an audio string. Note that in one embodiment, random spacing 325 is added between the audio objects as they are concatenated. After concatenating the audio objects 320, the resulting audio string is then distorted by the selective use of filtering and the addition of noise. For example, as described above, in one embodiment, random babble is generated 335 by overlapping random samples extracted from either synthesized speech 315 or recorded speech 340. Further, in one embodiment, each sample of synthesized speech 315 or recorded speech 340 is randomly weighted in the process of generating the random babble 335.

As described above, other filtering or distortion effects that are applied to the concatenated audio string include, for example, reverb 345, popping noise 350, clipping 355, narrow band noise 360, time domain distortions 365, frequency domain distortions 370, etc. Again, any type or amount of audio filtering or distortion may be applied in distorting the audio string for the purpose of creating the audio challenge string.

Once the audio challenge string has been generated, the next step is to simply present 375 that audio challenge string to an unknown user via conventional sound generation devices, such as, for example, computer speakers or headphones. A typed response from the unknown user is then compared to the known objects represented in the challenge string to determine whether the user response matches 380 the challenge string either partially or completely. If the typed user response matches 380 the challenge string, either completely, or within a predetermined threshold, then the unknown user is deemed to be a human user 385. However, if the typed user response fails to match 380 the challenge string, either completely, or within a predetermined threshold, then the unknown user is deemed not to be a human user 390.

In one embodiment, the parameters of various distortions, such as strength with which noise is added, length of reverb filter, and so on are varied for each successive challenge, thereby making it more difficult for an attacker to determine the settings of the system.

In an alternate embodiment, where the typed user response fails to match 380 the challenge string, either completely, or within a predetermined threshold, then the user is again presented 375 with the same challenge string for one or more additional attempts at identification of the challenge string. In yet another embodiment, where the typed user response fails to match 380 the challenge string, either completely, or within a predetermined threshold, then a new challenge string 305 to 370 is created as described above, and presented 375 to the user for identification. Note that in this embodiment, the user may alternately choose to select another challenge language 300 for use in generating the new challenge string.

Finally, whether the user is deemed to be human 385, or not human 390, the process is terminated. Note that the results of this identification process can then be used for many purposes, such as, for example, allowing the unknown user access to a particular computer or computer process (if deemed to be human 385), or denying the unknown user access to a particular computer or computer process (if deemed not to be human 390).

The foregoing description of the invention has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the audio challenger described herein. It is intended that the scope of the invention be limited not by this detailed description, but rather by the claims appended hereto.

What is claimed is:

1. A computer-implemented process for providing an automatic human interactive proof, comprising:
selecting two or more audio objects from a library comprising a plurality of audio objects;
concatenating the selected audio objects into an audio string;
distorting the audio string with one or more distortions; and
presenting the distorted audio string to an unknown user for identification.

2. The computer-implemented process of claim 1 wherein distorting the audio string comprises generating random babble noise and adding the random babble noise to the audio string.

3. The computer-implemented process of claim 2 wherein generating random babble noise comprises:
randomly sampling one or more segments of speech, with each random sample being equal in duration to the audio string; and
overlaying each random sample to generate the random babble noise.

4. The computer-implemented process of claim 3 further comprising randomly weighting each random sample prior to overlaying the random samples to generate the random babble noise.

5. The computer-implemented process of claim 1 wherein distorting the audio string comprises adding reverberation random babble noise to the audio string.

6. The computer-implemented process of claim 1 wherein distorting the audio string comprises adding reverberation to the audio string.

7. The computer-implemented process of claim 1 wherein distorting the audio string comprises adding popping noise to the audio string.

8. The computer-implemented process of claim 1 wherein distorting the audio string comprises clipping the audio string.

9. The computer-implemented process of claim 1 wherein distorting the audio string comprises adding narrow band sounds to the audio string.

10. The computer-implemented process of claim 1 wherein distorting the audio string comprises applying time domain distortions to the audio string.

11. The computer-implemented process of claim 1 wherein distorting the audio string comprises applying frequency domain distortions to the audio string.

12. The computer-implemented process of claim 1 wherein distorting includes distorting the audio string with two or more of:
adding random babble noise to the audio string;
adding reverberation to the audio string;
adding popping noise to the audio string;
clipping the audio string;
adding narrow band sounds to the audio string;
applying time domain distortions to the audio string; and
applying frequency domain distortions to the audio string.

13. The computer-implemented process of claim 1 wherein each of the plurality of audio objects in the library includes a speech clip representing any of digits, letters, numbers, and words, and a character-based representation of each speech clip.

14. The computer-implemented process of claim 1 wherein concatenating the selected audio objects into an audio string includes inserting random pauses between each audio object.

15. The computer-implemented process of claim 1 wherein parameters of the one or more distortions are varied with each instance of producing the distorted audio string.

16. The computer-implemented process of claim 1 further comprising comparing a textual response to distorted audio string.

17. The computer-implemented process of claim 16 wherein the unknown user is identified as human if the textual response matches the audio objects represented by the distorted audio string.

18. The computer-implemented process of claim 16 wherein the unknown user is identified as human if the textual response at least partially matches the audio objects represented by the distorted audio string within a predetermined error threshold.

19. The computer-implemented process of claim 16 wherein the unknown user is identified as a computing device if the textual response does not match the audio objects represented by the distorted audio string.

20. The computer-implemented process of claim 16 wherein the unknown user is identified as a computing device if the textual response does not at least partially match the audio objects represented by the distorted audio string within a predetermined error threshold.

21. The computer-implemented process of claim 1 further comprising user selection of an audio object language.

22. A system for determining whether an unknown computer user is a human, comprising:
automatically selecting two or more audio objects from an object library;
automatically concatenating the selected audio objects into an audio string;
generating babble noise by sampling one or more segments of speech and overlaying each sample to generate the babble noise;
adding the babble noise to the audio string to create an audio challenge string;
presenting the audio challenge string to an unknown computer user for identification;
comparing a textual response from the unknown user to the prerecorded audio objects selected from the object library; and
determining the unknown user to be human if the textual response matches the audio objects selected from the object library within a predetermined error threshold.

23. The system of claim 22 further comprising user selection of an object library language for use in creating the audio challenge string.

24. The system of claim 22 further comprising randomly weighting each sample prior to overlaying the samples to generate the babble noise.

25. The system of claim 22 wherein the segments of speech are any of segments of human speech and automatically synthesized segments of speech.

26. The system of claim 22 further comprising distorting the audio string by at least two of:
adding reverberation to the audio string;
adding popping noise to the audio string;
clipping the audio string;
adding narrow band sounds to the audio string;
applying time domain distortions to the audio string; and
applying frequency domain distortions to the audio string.

27. The system of claim 26 wherein parameters of at least one distortion of the audio string are randomized with each instance of creating the audio challenge string.

28. The system of claim 22 wherein each of the audio objects in the object library includes a speech clip representing any of digits, letters, numbers, and words, and a character-based representation of each speech clip.

29. The system of claim 22 wherein concatenating the selected audio objects further comprises inserting random temporal spaces between each audio object.

30. The system of claim 29 wherein the random temporal spaces are filled with noise.

31. The system of claim 22 further comprising determining the unknown user not to be human if the textual response does not match the audio objects selected from the object library within a predetermined error threshold.

32. A method for generating an audio-based challenge for an automated human interactive proof, comprising:
automatically selecting two or more audio objects;
automatically concatenating the selected audio objects into an audio string with the addition of random temporal spaces between each audio object;
applying a randomized reverberation filter to the concatenated audio string; and
presenting the filtered audio string as an audio challenge to an unknown computer user for identification.

33. The method of claim 32 further comprising a user selectable language to be used in generating the audio challenge.

34. The method of claim 32 further comprising automatically comparing a textual response from the unknown computer user to the selected audio objects and identifying the unknown user as human when the textual response matches the selected audio objects.

35. The method of claim 32 further comprising automatically comparing a textual response from the unknown computer user to the selected audio objects and identifying the unknown user as a computer when the textual response does not match the selected audio objects.

36. The method of claim 32 further comprising generating random babble noise by randomly sampling one or more segments of speech and overlaying each sample to generate the random babble noise and adding the random babble noise to the filtered audio string before presenting the filtered audio string as an audio challenge to the unknown computer user.

37. The method of claim 36 further comprising randomly weighting each random sample prior to overlaying the random samples.

38. The method of claim 36 wherein the segments of speech are any of segments of human speech and segments of automatically synthesized speech.

39. The method of claim 32 further comprising distorting the filtered audio string before presenting the filtered audio string as an audio challenge to the unknown computer user by at least one of:
adding popping noise to the audio string;
clipping the audio string;
adding narrow band sounds to the audio string;
applying time domain distortions to the audio string; and
applying frequency domain distortions to the audio string.

40. The method of claim 32 wherein parameters defining of one or more of the distortions of the filtered audio string are randomly varied with each instance of generating the audio challenge.

41. The method of claim 32 wherein the random temporal spaces are filled with white noise.
